(19) United States
(12) Patent Application Publication
(10) Pub. No.: US 2025/0252303 A1
(43) Pub. Date: Aug. 7, 2025

(54) MANY-IN-ONE ELASTIC NEURAL NETWORK

(71) Applicant: NVIDIA Corporation, Santa Clara, CA (US)

(72) Inventors: Ruisi Cai, Austin, TX (US); Saurav Muralidharan, San Jose, CA (US); Gregory Heinrich, Aix-en-Provence (FR); Hongxu Yin, San Jose, CA (US); Chen-Han Yu, Mountain House, CA (US); Jan Kautz, Lexington, MA (US); Pavlo Molchanov, Mountain View, CA (US)

(21) Appl. No.: 18/932,976

(22) Filed: Oct. 31, 2024

Related U.S. Application Data
(60) Provisional application No. 63/549,778, filed on Feb. 5, 2024.

(51) Int. Cl. G06N 3/08; G06N 3/045

(52) U.S. Cl. CPC G06N 3/08; G06N 3/045

(57) ABSTRACT

Apparatuses, systems, and techniques to select, from an elastic neural network, a sub-network that satisfies deployment constraints. In at least one embodiment, a sub-network is selected from an elastic neural network by using routers trained to select candidate sets of attention heads for multi-head attention (MHA) sub-blocks and candidate sets of neurons for multi-layer perceptron (MLP) sub-blocks.

### CLAIM OF PRIORITY

This application claims the benefit of U.S. Provisional Application No. 63/549,778 titled “MANY-IN-ONE FLEXIBLE LARGE LANGUAGE MODEL,” filed Feb. 5, 2024, the entire contents of which are incorporated herein by reference.

### FIELD

In at least one embodiment, a processor comprises one or more arithmetic logic units (ALUs) to perform training and/or inferencing using neural networks. In at least one embodiment, a processor comprises one or more arithmetic logic units (ALUs) to perform training and/or inferencing using elastic neural networks that include a number of unique subnetworks.

### BACKGROUND

Large language models (LLMs) have revolutionized real-world natural language processing applications and have shown impressive proficiency in understanding difficult contexts. However, the substantial size of these models, typically running into several billion parameters, imposes significant constraints on their utilization in scenarios characterized by limited memory and computational resources. Model developers often provide one or more dense models to satisfy the trade-off between efficiency and accuracy. For instance, the Llama-2 model family offers three different variants with 7 billion, 13 billion, and 70 billion parameters, while the Pythia family offers a selection of eight models with sizes ranging from 80 million to 12 billion parameters. Customizable models have been developed with multiple sub-networks that allow for extraction, from a single trained model, of sub-models capable of satisfying memory and computational resource constraints. Such models typically use a supernet with elastic, nested components. Mixture-of-experts (MoE) models, which include multiple specialized models known as experts, provide for reduced computational costs via sparse activation, whereby only a subset of experts is activated for a particular input.

### BRIEF DESCRIPTION OF THE DRAWINGS

Embodiments of the present disclosure are described in detail below with reference to the attached drawing figures, wherein:

FIG. 1 is a block diagram of an elastic neural network block, according to at least one embodiment;

FIGS. 2A through 2D are block diagrams illustrating candidate sets of attention heads of an MHA layer, according to at least one embodiment;

FIGS. 3A through 3D are block diagrams illustrating candidate sets of neurons of an MLP, according to at least one embodiment;

FIGS. 4A through 4C are block diagrams illustrating multiple neural network blocks of an elastic neural network deployed in different environments, according to at least one embodiment;

FIG. 5 is a flow diagram illustrating a process for training an elastic neural network, according to at least one embodiment;

FIGS. 6A through 6C illustrate cumulative activation magnitude per attention head and neuron of a pretrained neural network, and sorting of attention heads and neurons in decreasing order of cumulative activation magnitude, according to at least one embodiment;

FIG. 7 illustrates, random selection of a candidate set of attention heads of an MHA layer and random selection of a candidate set of neurons of an MLP during continued training, according to at least one embodiment;

FIG. 8 is a block diagram illustrating surrogate model training, according to at least one embodiment;

FIG. 9 is a block diagram illustrating training of attention routers and perceptron routers of an elastic neural network, according to at least one embodiment;

FIG. 10 is a conceptual diagram of a processing system implemented using a PPU, suitable for use in implementing some embodiments of the present disclosure.

FIG. 11A illustrates an exemplary system in which the various architecture and/or functionality of the various previous embodiments may be implemented.

FIG. 11B illustrates components of an exemplary system that can be used to train and utilize machine learning, in at least one embodiment.

FIG. 12 illustrates an exemplary streaming system suitable for use in implementing some embodiments of the present disclosure.

### DETAILED DESCRIPTION

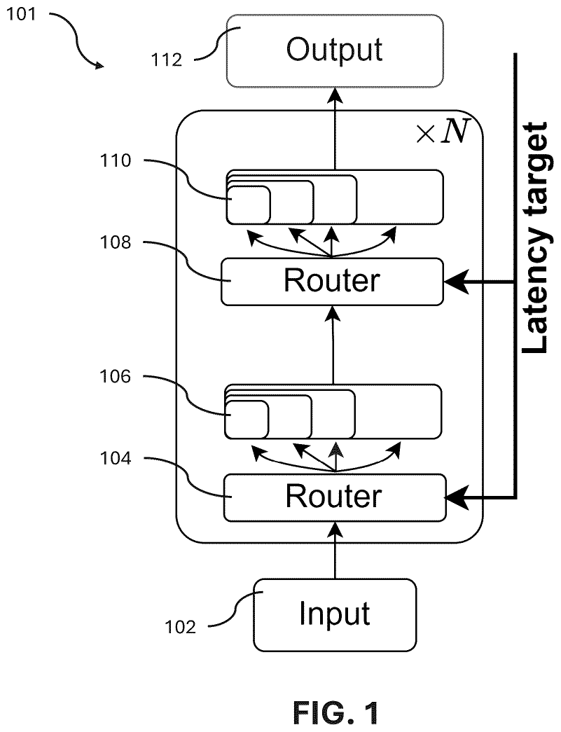

FIG. 1 illustrates a block diagram of an elastic neural network block 101, according to at least one embodiment. Elastic neural network block 101 includes multi-head attention (MHA) sub-block 106 and multi-layer perceptron (MLP) sub-block 110. Elastic neural network block 101 is configured to receive input 102 and generate, by processing the input 102 via MHA sub-block 106 and MLP sub-block 110, output 112. Elastic neural network block 101 further includes attention router 104 and perceptron router 108. Attention router 104 and MHA sub-block 106 provide an elastic MHA mechanism, and perceptron router 108 and MLP sub-block 110 provide an elastic MLP. The elastic MHA mechanism and the elastic MLP provide an architecture selection mechanism, via which a neural network including one or more instances of the neural network block 101 can select, from an exponential number of unique sub-networks, a single sub-network adapted to meet user-defined objectives (e.g. latency, memory, accuracy, etc.).

In at least one embodiment, an elastic neural network includes N blocks, each block including an instance of elastic neural network block 101. In at least one embodiment, elastic neural network block 101 is a transformer block, and a generative pretrained transformer (GPT) includes N blocks, each block including an instance of the transformer block. In at least one embodiment, the elastic neural network including N instances of neural network block 101 can be represented as Yᵢ=fᵢ(Xᵢ, Wᵢ^{j}), where i∈[1, N] refers to the block index, Xᵢ denotes the block input (having dimensions of B×C representing batch X embedding dimension), Wᵢ denotes the parameters of the block, and each Wᵢ^{j}, j∈[1, K] represents a different parameter matrix for the same operation fᵢ for layer i. Elastic neural network Yᵢ=fᵢ(Xᵢ, Wᵢ^{j}) can operate, once deployed, as any one of an exponential number (e.g. K^{N}, assuming K candidates per block and N blocks) of sub-networks, each with different runtime and accuracy characteristics. In this manner, elastic neural network Yᵢ=fᵢ(Xᵢ, Wᵢ^{j}) can rapidly adapt to specific latency and accuracy targets at inference, automatically routing tokens through sub-networks for improved performance and efficiency without requiring additional fine-tuning. In at least one embodiment, elastic neural network Yᵢ=fᵢ(Xᵢ, Wᵢ^{j}) is hardware-adaptive. In at least one embodiment, elastic neural network Yᵢ=fᵢ(Xᵢ, Wᵢ^{j}) is input-adaptive. In at least one embodiment, elastic neural network Yᵢ=fᵢ(Xᵢ, Wᵢ^{j}) is both hardware- and input-adaptive.

In at least one embodiment, the input 102 provided to neural network block 101 has dimensions B (batch size), T (sequence length/number of tokens per sequence), and C (channel dimension/size of embedding vector per token). For example, the input 102 provided to the neural network block 101 can be a batch of up to B=64 sequences, each sequence having up to T=512 tokens, each token being represented by a C=4096 dimensional embedding vector, though the values of B, T, and C can also be much larger. In at least one embodiment, the input 102 provided to neural network block 101 includes a plurality of embedding vectors (each of dimension C), each embedding vector corresponding to a token in a sequence of tokens (having a sequence length T) generated by tokenizing one or more input sentences provided to the neural network that includes neural network block 101. In at least one embodiment, input 102 includes a plurality of embedding vectors, each corresponding to a token in a sequence of tokens generated by tokenizing raw text provided to a GPT that includes neural network block 101.

The MHA sub-block 106 includes a plurality of attention heads. Each respective attention head of the plurality of attention heads includes a respective set of three different learned weight matrices: (i) a query weight matrix for transforming an input vector into a query vector, (ii) a key weight matrix for transforming an input vector into a key vector, and (iii) a value weight matrix for transforming an input vector into a value vector. In at least one embodiment, each respective attention head generates, using the query, key, and value weight matrices, a respective attention head vector for each token. In at least one embodiment, MHA sub-block 106 further includes a concatenation layer, which concatenates the plurality of attention head vectors that correspond to a particular token to produce, for that token, a concatenated attention head vector. In at least one embodiment, MHA sub-block 106 includes a final linear layer, which includes an additional weight matrix that transforms the concatenated attention head vector corresponding to a particular token into a final MHA layer output vector for the particular token. The MHA sub-block 106 provides context-aware representations corresponding to each token, thereby providing the ability to capture both local and long-range relationships and dependencies between different tokens in a tokenized input sequence. Increasing the number of attention heads in the MHA sub-block 106 allows a wider range of relationships and dependencies to be captured, potentially leading to improved model performance for complicated tasks. However, a larger number of attention heads increases the computational costs associated with both training the model and using the model at inference. Furthermore, a larger number of attention heads can potentially lead to overfitting on smaller datasets, thereby reducing model performance.

Attention router 104 is configured to route the input 102 to a set of attention heads of MHA sub-block 106. In at least one embodiment, the set of attention heads (i.e. a candidate set) to which the attention router 104 routes the input 102 is selected based on one or more target deployment constraints. In at least one embodiment, target deployment constraints include any one or more of a latency target, an accuracy target, a memory constraint, or a processor utilization related constraint. In at least one embodiment, the candidate set to which the attention router 104 routes the input 102 is selected based on both (a) one or more target deployment constraints and (b) the input 102 itself. In at least one embodiment where the candidate set is selected based on both target deployment constraints and the input 102 itself, the attention router 104 selects the candidate set based on the output of a preceding MLP sub-block. In at least one embodiment, different candidate sets are selected for processing different tokens within the same sequence. In at least one embodiment, input 102 is provided in the form of at least one sequence of T tokens, each token being represented by C-dimensional vector, and the attention router 104 selects a candidate set for each of the T tokens.

In at least one embodiment, the MHA sub-block 106 includes L attention heads and K nested candidate sets such that each ith candidate set (i=1, 2, . . . , K) includes

$$i \frac{L}{K}$$

attention heads. In at least one such embodiment, the L attention heads are sorted by order of importance, as determined by accumulated magnitude of activations, during a pretraining process such that each ith candidate set includes the

$$i \frac{L}{K}$$

most important attention heads. In at least one embodiment, the L attention heads are sorted by order of importance as determined from gradient values during a pre-training process. In at least one embodiment, the L attention heads are sorted by order of importance as determined by magnitude of activations during inference on a calibration dataset. In at least one embodiment, the L attention heads are sorted by order of importance as determined via an alternative technique. For example, in at least one embodiment, the MHA sub-block 106 includes 32 attention heads (sorted 1 through 32 by order of importance) and four nested candidate sets: a first candidate set including attention heads numbered 1 through 8, a second candidate set including attention heads numbered 1 through 16, a third candidate set including attention heads numbered 1 through 24, and a fourth candidate set including all 32 attention heads. The attention router 104 is configured to select, from the four candidate sets, a set of attention heads to route the input 102 to. In this manner, the attention router 104 selects, based on the target deployment constraints—and optionally, also based on the input 102 itself—how many attention heads to use for processing the input 102.

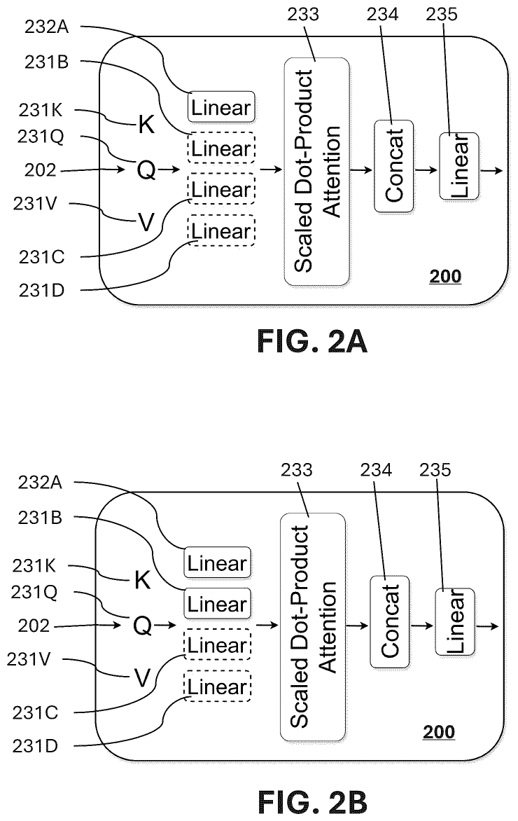

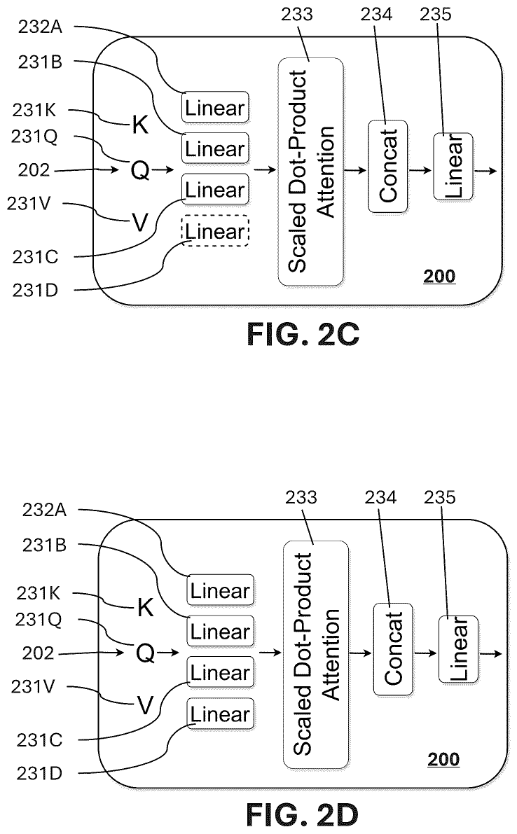

FIGS. 2A through 2D are block diagrams illustrating candidate sets of attention heads of an MHA sub-block, according to at least one embodiment. The MHA sub-block 200 can, according to at least one embodiment, be MHA sub-block 106 of neural network block 101. MHA sub-block 200 includes key, query, and value tensors 231K, 231Q, and 231V. Each key, query, and value tensor includes a learned key, query, or value weight matrix corresponding to an attention head of the MHA sub-block 200. The key, query, and value tensors 231K, 231Q, and 231V thereby respectively include, for each ith attention head, learned weight matrices W^{Q,i}, W^{K,i}, W^{V,i}. In the embodiment illustrated in FIGS. 2A through 2D, the MHA sub-block 200 includes four attention heads. Each ith attention head in the selected candidate set of attention heads of MHA sub-block 200 processes, in linear layers 232A through 232D, each respective embedding vector in input 202 by computing, using the ith learned weight matrices W^{Q,i}, W^{K,i}, W^{V,i} of key, query, and value tensors 231K, 231Q, and 231V, a query vector, a key vector, and a value vector corresponding to the respective embedding vector/token. Each ith attention head then computes, in scaled dot-product attention layer 233, attention scores, attention weights, and a weighted sum of value vectors for each respective embedding vector/token. The weighted sum of value vectors is provided as the output of the ith attention head (also referred to as the ith attention head vector) for the respective embedding vector/token. In concatenation layer 234, the i attention head vectors provided by the i attention heads are concatenated to produce a concatenated attention head vector, and in linear layer 235, the concatenated attention head vector is transformed into a final MHA layer output for the respective embedding vector/token.

In FIG. 2A, each respective embedding vector in input 202 is routed to a single attention head, resulting in processing at a single linear layer 232A. In FIG. 2B, each respective embedding vector in input 202 is routed to a candidate set of attention heads that includes two attention heads, resulting in processing at linear layers 232A and 232B. In FIG. 2C, each respective embedding vector in input 202 is routed to a candidate set of attention heads that includes three attention heads, resulting in processing at linear layers 232A through 232C. In FIG. 2D, each respective embedding vector in input 202 is routed to a candidate set of attention heads that includes all four attention heads, resulting in processing at linear layers 232A through 232D.

In at least one embodiment, an elastic MHA mechanism provided by attention router 104 and MHA layer 106 can be represented as:

$${MHA}^{j} ( x ) = Concat ( {head}_{1} , … {head}_{{d}_{j}} ) \cdot ( {I}_{{d}_{j} H} {W}^{o} ) , {head}_{i} = Attn ( {XW}^{Q , i} , {XW}^{K , i} , {XW}^{V , i} ) ,$$

where, I_{d}_{ⱼ}_{H} is a diagonal matrix with the first d H elements being 1 and the rest being 0s, dⱼ is the number of heads selected, H is the size of a single head, L is the total number of heads, and W^{Q,i}, W^{K,i}, W^{V,i}∈ [symbol] and W^{O}∈ [symbol] . Different heads can be computed/selected via weight slicing.

The MLP sub-block 110 includes an input layer, an output layer, and one or more hidden layers. The input layer, the output layer, and each of the one or more hidden layers includes a plurality of neurons. The input layer includes an input weight matrix, each hidden layer includes a respective hidden layer weight matrix, and the output layer includes an output layer weight matrix. The number of neurons in the input layer corresponds to the number of dimensions in the input data (i.e., in the embodiment of FIG. 1, the dimensionality of the final MHA layer output vector), and the number of neurons in the output layer is a hyperparameter that determines the dimensionality of the output of MLP sub-block 110. The hidden layers provide the MLP sub-block 110 with the ability to ascertain complex patterns and relationships in the data it receives, and both the width (i.e. the number of neurons per hidden layer) and the depth (i.e. the number of hidden layers) impact the capacity of the MLP sub-block 110 to learn and generalize from the data. Increasing the width and depth improves the accuracy of the inferences drawn by a model, but also increases the computational costs associated with both training the model and using the model at inference.

Perceptron router 108 is configured to route the output of MHA sub-block 106 to a set of neurons of one or more hidden layers of the MLP sub-block 110. In at least one embodiment, the set of neurons (i.e. a “candidate set”) to which the perceptron router 108 routes the output of MHA sub-block 106 is selected based on one or more target deployment constraints. In at least one embodiment, target deployment constraints include any one or more of a latency target, an accuracy target, a memory constraint, or a processor utilization. In at least one embodiment, the candidate set to which the perceptron router 108 routes the output of MHA sub-block 106 is selected based on both (a) one or more target deployment constraints and (b) the input 102 itself. In at least one embodiment where the candidate set is selected based on both target deployment constraints and the input 102 itself, the perceptron router 108 selects the candidate set based on the output of the MHA sub-block 106. In at least one embodiment, different candidate sets are selected for processing different tokens within the same sequence. In at least one embodiment, the input 102 is provided in the form of at least one sequence of T tokens, each token being represented by C-dimensional vector, and the perceptron router 108 selects a candidate set for each of the T tokens.

In at least one embodiment, the MLP sub-block 110 includes a single hidden layer with D neurons and K nested candidate sets such that each jth candidate set (j=1, 2, . . . , K) includes

$$j \frac{D}{K}$$

neurons. In at least one such embodiment, the D neurons are sorted by order of importance, as determined by accumulated magnitude of activations during a pretraining process, such that each jth candidate set includes the

$$j \frac{D}{K}$$

most important neurons. In at least one embodiment, the D neurons are sorted by order of importance as determined from gradient values during a pre-training process. In at least one embodiment, the D neurons are sorted by order of importance as determined by magnitude of activations during inference on a calibration dataset. In at least one embodiment, the D neurons are sorted by order of importance as determined via an alternative technique. In at least one embodiment, the MLP sub-block 110 includes N hidden layers such that each nth (n=1, 2, . . . , N) hidden layer has Dₙ neurons and K nested candidate sets such that each jth candidate set (j=1, 2, . . . , K) includes, for the nth hidden layer,

$$j \frac{{D}_{n}}{K}$$

neurons. In at least one such embodiment, the Dₙ neurons are sorted by order of importance, as determined by accumulated magnitude of activations during a pretraining process, such that each jth candidate set includes, for each nth hidden layer, the

$$j \frac{{D}_{n}}{K}$$

most important neurons. For example, in at least one embodiment, the MLP sub-block 110 includes an input layer with 12,288 neurons and a single hidden layer with 49,152 neurons (sorted 1 through 49,152 by order of importance). The hidden layer includes four nested candidate sets: a first candidate set including neurons sorted 1 through 12,288, a second candidate set including neurons sorted 1 through 24,576, a third candidate set including neurons sorted 1 through 36,864, and a fourth candidate set including all 49,152 neurons. As an alternative example, in at least one embodiment, the MLP sub-block 110 includes an input layer with 12,288 neurons and two hidden layers: a first with 49,152 neurons (sorted 1 through 49,152 by order of importance) and a second with 98,304 neurons (sorted 1 through 98,304 by order of importance). The hidden layers include four nested candidate sets: a first candidate set including neurons sorted 1 through 12,288 in the first hidden layer and neurons sorted 1 through 24,576 in the second hidden layer, a second candidate set including neurons sorted 1 through 24,576 in the first hidden layer and neurons sorted 1 through 49,152 in the second hidden layer, a third candidate set including neurons sorted 1 through 36,864 in the first hidden layer and neurons sorted 1 through 73,728 in the second hidden layer, and a fourth candidate set including all 49,152 neurons in the first hidden layer and all 98,304 neurons in the second hidden layer. The perceptron router 108 is configured to select, from the four candidate sets, a set of hidden layer neurons to route the output of MHA sub-block 106 to. In this manner, the perceptron router 108 selects, based on the target deployment constrains—and optionally, also based on the input 102 itself—how many hidden layer neurons to use for processing the output of MHA sub-block 106.

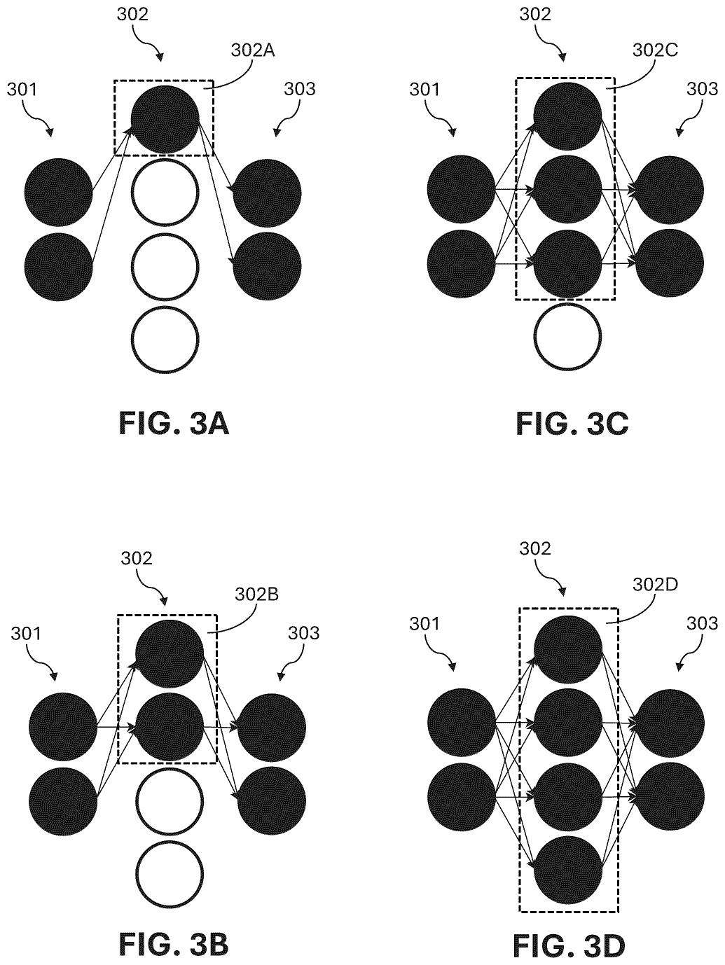

FIGS. 3A through 3D illustrate candidate sets of neurons of an MLP sub-block, according to at least one embodiment. The MLP sub-block 300 can, according to at least one embodiment, be MLP sub-block 110 of neural network block 101. The MLP sub-block 300 includes an input layer 301, a hidden layer 302, and an output layer 303. The hidden layer 302 includes four candidate sets of neurons: 302A, 302B, 302C, and 302D. In FIG. 3A, input received at input layer 301 is routed to candidate set 302A, in FIG. 3B, input received at input layer 301 is routed to candidate set 302B, in FIG. 3C, input received at input layer 301 is routed to candidate set 302C, and in FIG. 3D, input received at input layer 301 is routed to candidate set 302D.

In at least one embodiment, an elastic MLP provided by perceptron router 108 and MLP sub-block 110 can be represented as:

$${MLP}^{j} ( x ) = σ ( X \cdot {( {I}_{d j} {W}^{( 1 )} )}^{T} ) \cdot ( {I}_{{d}_{j}} {W}^{( 2 )} ) ,$$

where, I_{dj} is a diagonal matrix of size D×D where the first dⱼ diagonal elements are 1 and the rest are 0, with D being the maximum hidden dimension. In this way, the j^{th} MLP candidate only utilizes the first dⱼ hidden neurons from the corresponding shared matrices W·W⁽¹⁾ and W⁽²⁾ are the associated two weight matrices in MLP layers, with W⁽¹⁾, W⁽²⁾∈ [symbol] , and σ(·) refers to the non-linear activation function. For implementation, the diagonal matrix I can be replaced with a slicing operator that selects only the first dⱼ rows: I_{d}_{ⱼ}W⁽¹⁾=W⁽¹⁾[0:dⱼ,:]. For K experts (each of which corresponds to a candidate set of neurons), d₁<d₂< . . . <d_{K}, where d_{K}=D.

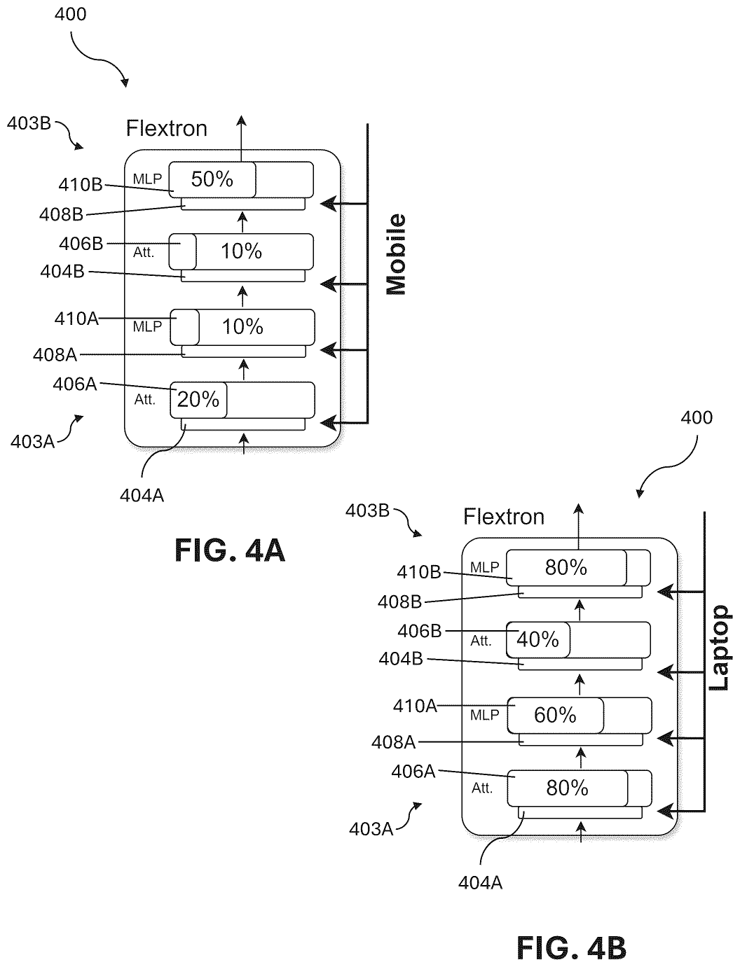

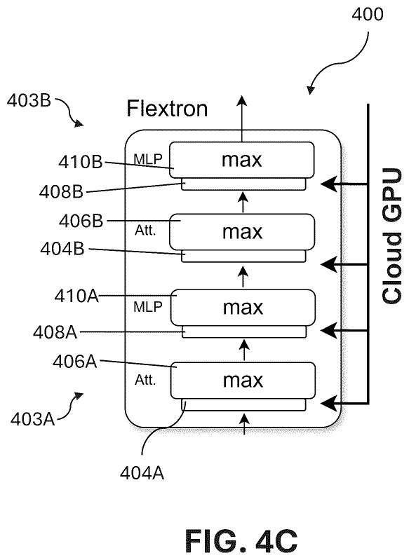

FIGS. 4A through 4C illustrate multiple neural network blocks of an elastic neural network deployed in different environments, according to at least one embodiment. FIG. 4A illustrates two blocks—each including an attention sub-block and an MLP sub-block—of an elastic neural network 400 deployed on a mobile device, FIG. 4B illustrates the two blocks of the elastic neural network deployed on a laptop, and FIG. 4C illustrates the two blocks of the elastic neural network deployed on a cloud-based GPU. The elastic neural network 400 includes a first elastic neural network block 401A and a second elastic neural network block 401B. In at least one embodiment, each of the first elastic neural network block 403A and the second elastic neural network block 403B is an instance of the neural network block 101 of FIG. 1. In at least one embodiment, elastic neural network 400 enables fast, zeroshot generation of hardware and input-adaptive sub-networks targeting various accuracy, latency and parameter constraints.

FIGS. 4A through 4C illustrate the flexible deployment of the elastic neural network 400, in which the candidate sets of attention heads and the candidate neurons of hidden layers of MLPs are selected by routers of the elastic neural network 400 to adapt the network based on constraints imposed by different deployment environments. For example, in FIG. 4A, attention router 404A of elastic neural network block 403A selects—in order to satisfy the constraints imposed by deployment on a mobile device—a candidate set of attention heads that constitutes 20% of the total number of attention heads of MHA sub-block 406A, while in FIG. 4B, attention router 404A selects—in order to satisfy the constraints imposed by deployment on a laptop—a candidate set of attention heads that constitutes 80% of the total number of attention heads of MHA sub-block 406A. Similarly, in FIG. 4C, attention router 404A selects a candidate set of attention heads that constitutes all attention heads of MHA sub-block 406A when the elastic neural network 400 is deployed on a cloud-based GPU. Attention router 404B similarly selects candidate sets of attention heads for MHA sub-block 406B, and perceptron routers 408A and 408B similarly select candidate sets of neurons for MLP sub-blocks 410A and 410B. In at least one embodiment, the attention routers 404A, 404B and the perceptron routers 408A, 408B select the candidate sets of attention heads and the candidate sets of neurons, respectively, based not only on the constraints imposed by deployment environment but also on the input to the elastic neural network 400.

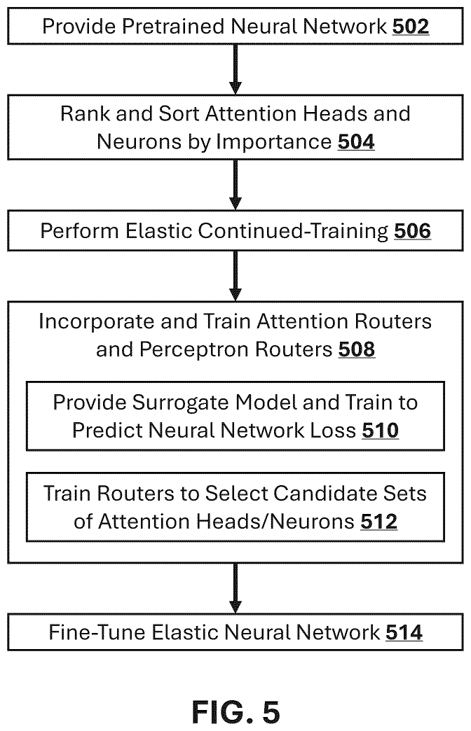

FIG. 5 is a flow diagram illustrating a process 500 for training an elastic neural network, according to at least one embodiment. At 502, a pretrained neural network is provided. In at least one embodiment, the pretrained neural network includes N neural network blocks, each neural network block including an MHA sub-block and an MLP sub-block. In at least one embodiment, the elastic neural network trained by the process 500 is the elastic neural network 400 of FIG. 4. In at least one embodiment, the elastic neural network trained by the process 500 includes N instances of neural network block 101 of FIG. 1.

At 504, importance ranking is performed for both (i) attention heads of MHA sub-blocks of the pretrained neural network and (ii) neurons of hidden layers of MLP sub-blocks of the pretrained model, thereby providing a sorted neural network. In at least one embodiment, importance ranking includes computing, for a small set of training data, an accumulated magnitude of activations for each attention head and for each neuron. In at least one embodiment, the importance of each attention head is computed as:

$${F}_{head}^{( i )} = {\sum }_{X} {‖ Attn ( {XW}^{Q , i} , {XW}^{K , i} , {XW}^{V , i} ) ‖}_{1} .$$

In at least one embodiment, the importance of each neuron is computed as:

$${F}_{neuron}^{( i )} = {\sum }_{X} {‖ {X ( {W}^{( 1 ) , r} )}^{T} ‖}_{1} .$$

W^{(1),r} refers to the rth row of the weight matrix W⁽¹⁾. In at least one embodiment, the set of training data includes a mere 512 sample inputs. In at least one embodiment, importance ranking includes sorting attention heads of MHA sub-blocks in order of importance, and sorting neurons of hidden layers of MLP sub-blocks in order of importance. In at least one embodiment, sorting attention heads of MHA sub-blocks is performed by permuting respective weight matrices in the MHA sub-blocks such that heads are stored in decreasing order of importance for every individual MHA sub-block. In at least one embodiment, sorting neurons of MLP sub-blocks is performed by permuting respective weight matrices in the MLP layers such that neurons are stored in decreasing order of importance for every individual MLP. In such embodiments, sub-networks can be selected by indexing the first several heads/neurons in each sub-block/layer, thus preserving essential knowledge encoded in important channels. In this manner, nested elastic layers are constructed, with neurons/heads sorted by importance, such that the first neurons/heads are the most important.

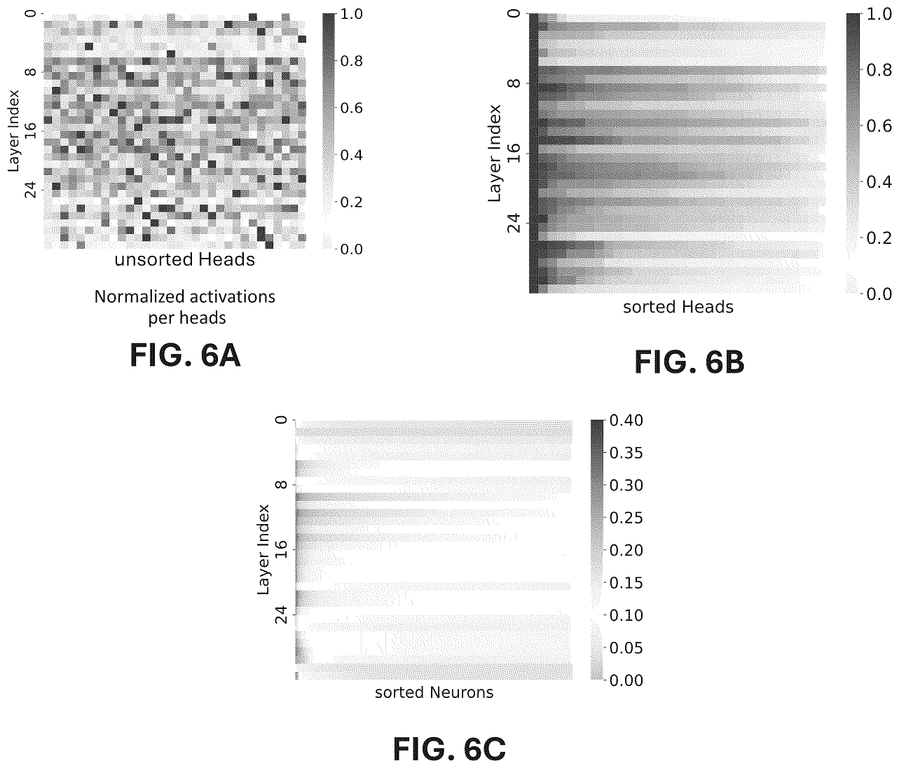

FIGS. 6A through 6C illustrate the outcome of importance ranking at 504, according to at least one embodiment. FIG. 6A illustrates, for the attention heads in the MHA sub-blocks—as they are ordered in the pretrained neural network provided at 502, the normalized accumulated magnitude of activations. FIG. 6B illustrates, for the attention heads in the various MHA sub-blocks—after they are sorted at 504, the normalized accumulated magnitude of activations. FIG. 6C illustrates, for the neurons of the various MLP sub-blocks—after they are sorted at 504, the normalized accumulated magnitude of activations.

At 506, elastic continued-training of the sorted neural network is performed, thereby providing an elastic-capable neural network. In at least one embodiment, the elastic continued-training of the sorted neural network at 506 includes updating weight matrices of the sorted neural network based on training runs performed using randomly selected subnetworks of the sorted neural network. The elastic continued-training thereby trains the sorted neural network to operate as any one of an exponential number of sub-networks. Since the number of possible candidate sub-networks can be prohibitively large (for example, there are 4⁶⁴ possible combinations for the 32-layer LLaMa2-7B model), the elastic continued-training at 506 randomly samples a subset thereof to simultaneously train all candidate sub-networks while keeping the total training time tractable.

In at least one embodiment, elastic continued-training at 506 includes performing a number of additional training runs in which (i) a data sample is selected from a training set, (ii) a forward pass is performed, using the data sample, for each of (a) the full, sorted neural network and (b)-(d) three randomly selected sub-networks, each randomly selected sub-network being provided by randomly selecting a candidate set of attention heads for each MHA sub-block and randomly selecting a candidate set of neurons for each MLP sub-block, (iii) computing, using a loss function, an average training loss for the four forward passes, and (iv) updating, based on the computed average training loss, individual weights of the weight matrices of the sorted neural network. In at least one embodiment, the elastic continued-training at 506 includes randomly generating a one-hot vector sᵢ for each block i and using the randomly generated one-hot vectors sᵢ to construct a candidate network [symbol] ⱼ, where sᵢ∈ [symbol] and Kᵢ represents, for block i, the number of candidate sets of attention heads for MHA sub-blocks and the number of candidate sets of neurons for MLP sub-blocks. [symbol] j is the random model indexed by j, where j∈[0, K−1]. In the at least one embodiment, the training loss is:

$${ℒ}_{joint} = {\sum }_{j = 0}^{k - 1} ℒ ( {j}_{} ( x ) , y ) .$$

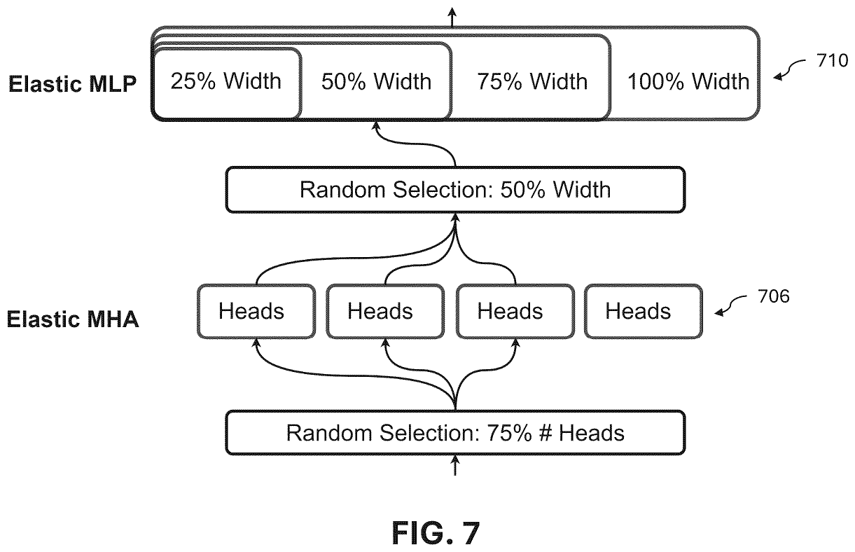

FIG. 7 illustrates, for a single neural network block, the random selection of a candidate set of attention heads of an MHA sub-block and the random selection of a candidate set of neurons of an MLP sub-block during the elastic continued-training at 506, according to at least one embodiment. In at least one embodiment, the random selection of candidate sets can be performed by randomly generating output for attention and perceptron routers in the elastic neural network. In FIG. 7, the candidate set of attention heads has been randomly selected as a candidate set that includes 75% of all attention heads of elastic MHA sub-block 706, and the candidate set of neurons has been randomly selected as a candidate set that includes 50% of the neurons of MLP sub-block 710.

At 508, attention routers and perceptron routers are provided, incorporated into the elastic-capable neural network, and trained to select candidate sets of attention heads of MHA sub-blocks and candidate sets of neurons of MLP sub-blocks, respectively, based on one or more target deployment constraints. In at least one embodiment, the attention routers and perceptron routers are trained to select candidate sets of attention heads and candidate sets of neurons additionally based on input provided to the neural network. As a result of 508, the trained elastic neural network is provided. As illustrated in FIG. 5, training the attention routers and perceptron routers is a two-stage process. A first stage 510 includes providing a surrogate model and training the surrogate model to predict, based on attention router and perceptron router outputs, a loss of the elastic neural network. A second stage 512 includes using the trained surrogate model to train the attention and perceptron routers to select candidate sets of attention heads of MHA layers and candidate sets of neurons of MLPs.

To train the attention routers and perceptron routers to select candidate sets of attention heads and neurons, respectively, an objective function is determined. In at least one embodiment, the objective is formulated as:

$${min}_{{S}_{t}} {\sum }_{t} {ℒ}_{CE} ( {{s}_{t}}_{} ) , s . t . Latency ( ) \leq {T}_{t} , = ( , {S}_{{T}_{t}} ) ,$$

where [symbol] is original network topology, Tₜ refers to a latency constraint of index t, S_{T}_{ₜ} denotes the related selection matrix, [symbol] , defines the selected topology based on latency constraint, [symbol] (·) is a function for selecting network topology, and [symbol] _{CE} refers to the cross-entropy loss. While Tₜ refers to a latency constraint in the above formulation, persons of ordinary skill in the art will understand that alternative or additional constraints, such as GPU memory, can also be provided, and that, in those scenarios, [symbol] defines the selected topology based on such alternative or additional constraints. The objective of selecting candidate sets of attention heads and neurons can be converted, by using a Lagrange multiplier and imposing a constraint, into directly minimizing the following loss term:

$$ℒ = {\sum }_{t} {ℒ}_{CE} ( ) + λ \cdot ( ) ,$$

where [symbol] represents the target constraint loss and λ is a hyperparameter that balances the cross-entropy loss and the target constraint loss. In at least one embodiment, a latency loss between the constraint Tₜ and actual model latency Latency( [symbol] ) can be represented by:

$$( ) = {\sum }_{t} max ( Latency ( ) - {T}_{t} , 0 ) .$$

In at least one embodiment, the attention routers and perceptron routers are trained at 508 to select candidate sets of attention heads of MHA sub-blocks and candidate sets of neurons of MLP sub-blocks, respectively, based on one or more target deployment constraints without consideration of input provided to the neural network. In at least one such embodiment, the resulting neural network can be, e.g., hardware-adapative, and the attention and perceptron routers can be said to perform static routing. In at least one such embodiment, the attention routers and perceptron routers automatically select sub-networks given only a target latency T (no input-adaptivity); each router receives the target latency requirement T as input and outputs a selection sᵢ of a candidate set of attention heads/neurons for each layer i, thereby automatically selecting a sub-network. The router selects the candidate sets with the following formulation:

sᵢ=argmax ( [symbol] ᵢ(T)),

where [symbol] is a small MLP that embeds a scalar value T (latency) into logits of a size of the predefined number of candidate sets (e.g. the K nested candidate sets).

In at least one embodiment, the attention routers and perceptron routers are trained at 508 to select candidate sets of attention heads of MHA sub-blocks and candidate sets of neurons of MLP sub-blocks, respectively, based on both one or more target deployment constraints and input provided to the neural network. In at least one such embodiment, the resulting network can be, e.g., both hardware- and input-adaptive and the attention and perceptron routers can be said to perform dynamic routing. In at least one such embodiment, the attention routers and perceptron routers automatically select sub-networks given both a target latency T and current hidden states hᵢ; each router receives both the target latency requirement T and current hidden states hᵢ as input and outputs a selection sᵢ of a candidate set of attention heads/neurons for each block i, thereby automatically selecting a sub-network. The routers then select the candidate sets with the following formulation:

sᵢ=argmax ( [symbol] ᵢ(T, hᵢ)),

where [symbol] ᵢ(T, hᵢ)=σ(T·W+hᵢW_{H}_{ᵢ}^{T}) [symbol] . The current hidden features hᵢ are, for the attention router of the MHA sub-block of the ith block, the output of the MLP sub-block of the (i−1)th block, and the current hidden features hᵢ are, for the perceptron router of the MLP sub-block of the ith block, the output of the MHA sub-block of the ith block. The current hidden features hᵢ are projected into an embedding space of dimension U by an MLP parameterized by W_{H}_{ᵢ}, which is a matrix of weights learned during router training. Similarly, the target latency T is projected into the embedding space of dimension U via simple scaling of the matrix W, which is a matrix of learned weights that is constant for all layers. In at least one embodiment, U is limited to 128. [symbol] is a matrix of weights learned during router training. Token-wise routing decisions are generated by aggregating the latency embedding vector with the hidden feature embedding vector and passing them through a linear layer.

At 510, a surrogate model is provided and trained to predict, based on attention router and perceptron router outputs, a loss of the elastic neural network. Attempting to train the attention and perceptron routers via standard, end-to-end deep learning techniques (in which gradients are propagated to the routers through the MHA sub-blocks and MLP sub-blocks to which they correspond) presents challenges. Specifically, such training techniques involve limited gradient propagation to the routers, making it difficult for the routers to learn. To overcome the challenges presented by limited gradient propagation to the routers, the surrogate model is trained, at 510, to predict the performance of the elastic neural network based on router outputs, and the routers are trained, at 512, to select candidate sets of attention heads/neurons based on a loss term provided directly to them by the trained surrogate model.

At 510, the surrogate model is trained to predict, based on a selection of candidate sets of attention heads/neurons that is provided as input, a loss value of the sub-network corresponding to the selected candidate sets as output. In at least one embodiment, the attention routers and perceptron routers are trained at 508 to select candidate sets based on both one or more target deployment constraints and input provided to the neural network, and the surrogate model also receives, during each training iteration as input, the hidden features output by the last MLP in the neural network, i.e. the final hidden states hy. During each training iteration of the surrogate model at 510, candidate sets of attention heads/neurons are randomly selected for each MHA layer/MLP in the neural network-thereby selecting a sub-network, and the random selection is provided to the surrogate model as input. To train the surrogate model, a surrogate model loss is computed by comparing the output of the surrogate model (which is a predicted loss of the sub-network) to a ground truth loss (which is computed as the actual loss of the sub-network for a particular training iteration). Gradients of the surrogate model loss are computed during a backward pass, and weights of the surrogate model are updated, based on the computed gradients, to minimize the surrogate model loss. To enable the surrogate model to accurately predict the loss of any sub-network that the elastic neural network is capable of operating as (such that the output of the surrogate model is a suitable proxy for the loss of said sub-network), the surrogate model is trained with a large batch size, in which each batch represents a random selection of candidate sets. In at least one embodiment, the elastic neural network is a GPT, the ground truth loss is a language model loss, and the surrogate model loss is a predicted language model loss.

In at least one embodiment, the surrogate model is a two-layer MLP that receives, as input, a matrix formed by concatenating candidate set selections made by every router in the elastic neural network, and that provides, as output, a predicted loss of the sub-network corresponding to said candidate set selections. In at least one embodiment, the surrogate model is represented as:

$$r = Concat ( {0}_{} ( T ) , {1}_{} ( T ) , … {N - 1}_{} ( T ) ) , ( r ) = σ ( {rW}_{{𝒮}_{1}}^{T} ) {W}_{{𝒮}_{2}} ,$$

where [symbol] and [symbol] are weights of size [symbol] ∈ [symbol] and [symbol] ∈ [symbol] , K is a number of candidate sets for each MHA sub-block/MLP sub-block, N is a number of blocks in the elastic neural network, and P is an internal dimension that can be selected by a network architect.

In at least one embodiment, the surrogate model is a two-layer MLP that receives, as input, both a matrix formed by concatenating candidate set selections made by every router in the elastic neural network and final hidden states of the elastic neural network, and that provides, as output, a predicted loss of the sub-network corresponding to said candidate set selections. The final hidden states are projected to the dimension of P using a linear matrix, and the projection is summed with the latency embedding before applying the activation function.

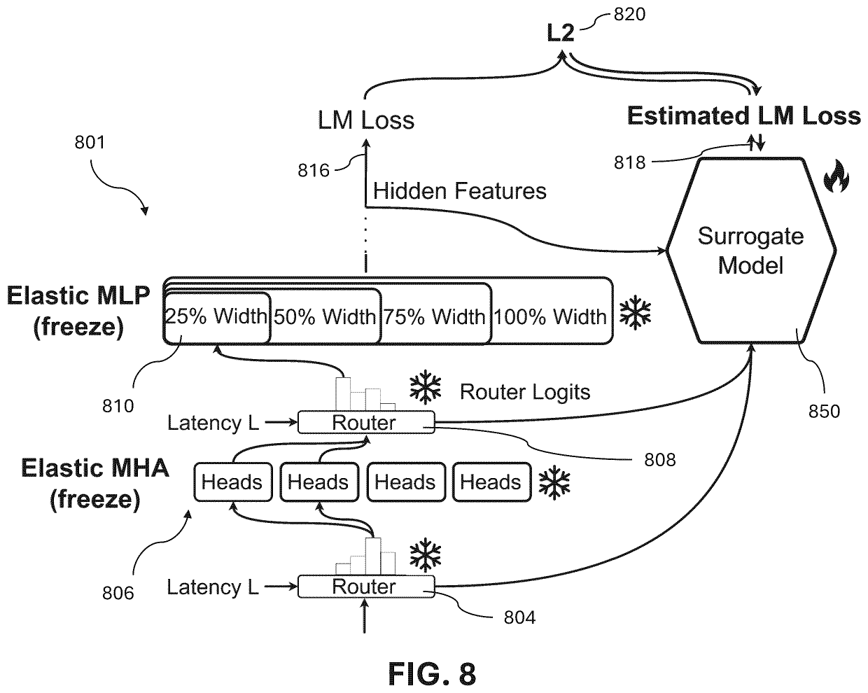

FIG. 8 is a block diagram illustrating a process for training a surrogate model, according to at least one embodiment. During the training of the surrogate model 850, an elastic neural network including elastic neural network block 801 receives, for each training iteration, input and generates, by processing the input via a sub-network formed from randomly selecting candidate sets of attention heads/neurons, output. The output is compared with a ground truth output, and a loss (i.e. LM loss 816) is computed. The elastic neural network block 801 includes attention router 804, MHA sub-block 806, perceptron router 808, and MLP sub-block 810. The randomly selected candidate set selections for attention router 804 and perceptron router 808 are provided, along with the other randomly selected candidate set selections, to the surrogate model 850. In at least one embodiment, hidden features of a final layer of the neural network are also provided to the surrogate model 850 as input. The surrogate model 850 provides, as output, an estimated loss (i.e. estimated LM loss 818), and L2 Loss 820 is computed as the mean-squared-error (MSE) loss between the LM loss 816 and the estimated LM loss 818.

A second stage 512 includes using the trained surrogate model to train the attention and perceptron routers to select candidate sets of attention heads of MHA sub-blocks and candidate sets of neurons of MLP sub-blocks. Once the surrogate model is trained at 510, the routers are trained are trained, at 512, to select candidate sets of attention heads/neurons based on a loss term provided directly to them by the trained surrogate model. In at least one embodiment, the routers are trained to simultaneously satisfy a latency loss objective and a model (e.g. a language model (LM)) loss objective. To train the routers at 512, the elastic neural network receives, at each training iteration, both target deployment constraints and model input. The routers of the elastic neural network select, based on the target deployment constraints, candidate sets of attention heads and neurons for each MHA sub-block and MLP sub-block, respectively, and the model input is processed according to the candidate set selections during a forward pass to generate model output. After the forward pass, the model latency is measured and used to determine a latency loss (e.g. a measure of the difference between the actual latency and a latency target provided as a target deployment constraint) and the surrogate model estimates, based on the candidate set selections, the model loss. Gradients of the latency loss and the surrogate model output are backpropagated to the routers, and router weights are updated, based on the gradients, to simultaneously minimize both the latency loss and the surrogate model output. In at least one embodiment, router weights are updated based on the gradients of the latency model loss at every training iteration, while router weights are updated based on the surrogate model output only for training iterations where the surrogate model output exceeds a threshold.

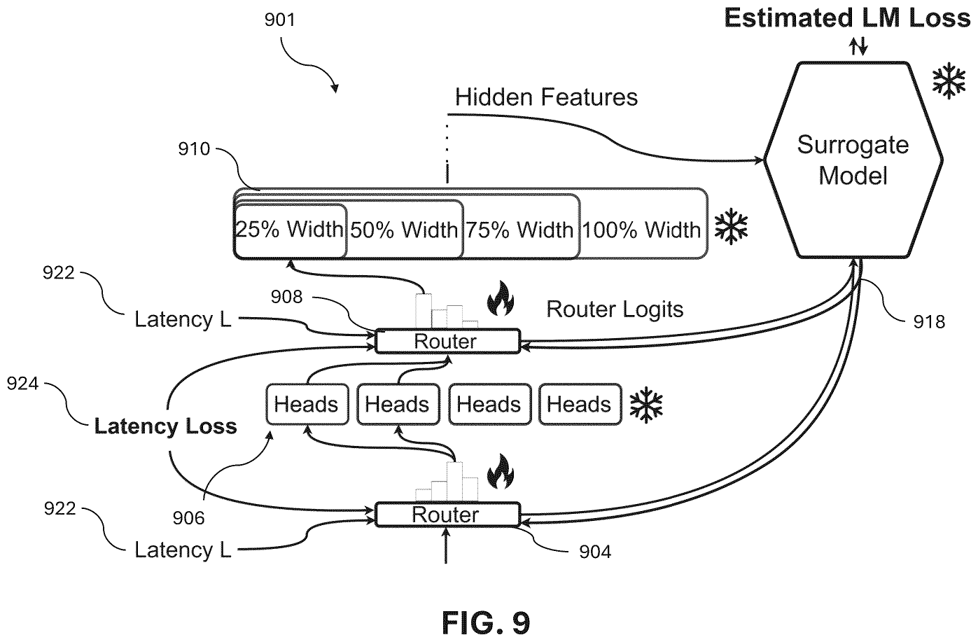

FIG. 9 is a block diagram illustrating a process for training attention and perceptron routers of an elastic neural network, according to at least one embodiment. FIG. 9 illustrates an elastic neural network block 901 of an elastic neural network. The elastic neural network block 901 includes attention router 904, MHA sub-block 906, perceptron router 908, and MLP sub-block 910. During the training of attention router 904 and perceptron router 908, the elastic neural network including elastic neural network block 901 receives, for each training iteration, both a latency target L 922, which is provided to both attention router 904 and perceptron router 908, and model input. Attention router 904 receives block input 902 (which corresponds to the model input), selects a candidate set of attention heads for MHA sub-block 906, and routes block input 902 to the selected candidate set of attention heads. MHA sub-block 906 processes block input 902 and provides MHA layer output to perceptron router 908. Perceptron router 908 receives the MHA sub-block output, selects a candidate set of neurons for MLP sub-block 910, and routes the MHA sub-block output to the selected candidate set of neurons. The MLP sub-block 910 processes the MHA sub-block output and provides block output 912, which is provided to subsequent blocks of the elastic neural network. Following the forward pass, a latency loss 924 is determined by comparing a measured latency to the latency target L 922, and gradients of the latency loss 924 are computed for attention router 904 and perceptron router 908. The surrogate model 950 receives the candidate set selections from the attention router 904 and the perception router 908—along with candidate set selections from other routers, and provides, as output, an estimated loss (i.e. estimated LM Loss 918). Gradients of the estimated LM Loss 918 are computed for attention router 904 and perceptron router 908. Model weights of attention router 904 and perceptron router 908 are updated based on the computed gradients of the latency loss 924 and the computed gradients of the estimated LM loss 918.

At 514, a fine-tuning process is performed in which the surrogate model is discarded and all weights of the elastic neural network—including router weights, MHA sub-block weights, and MLP sub-block weights—are updated using standard, end-to-end neural network training techniques.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

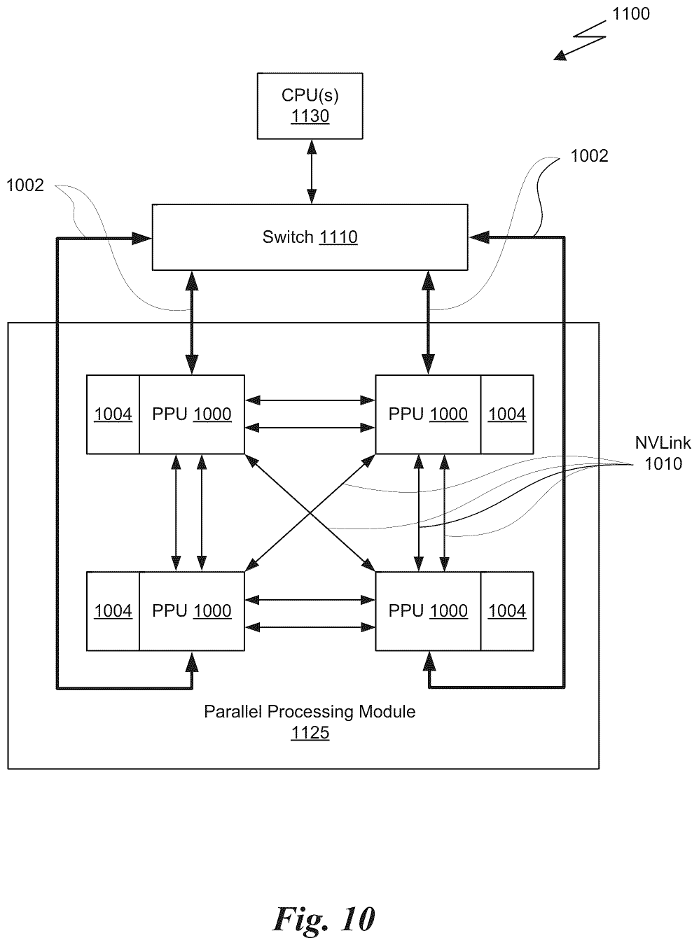

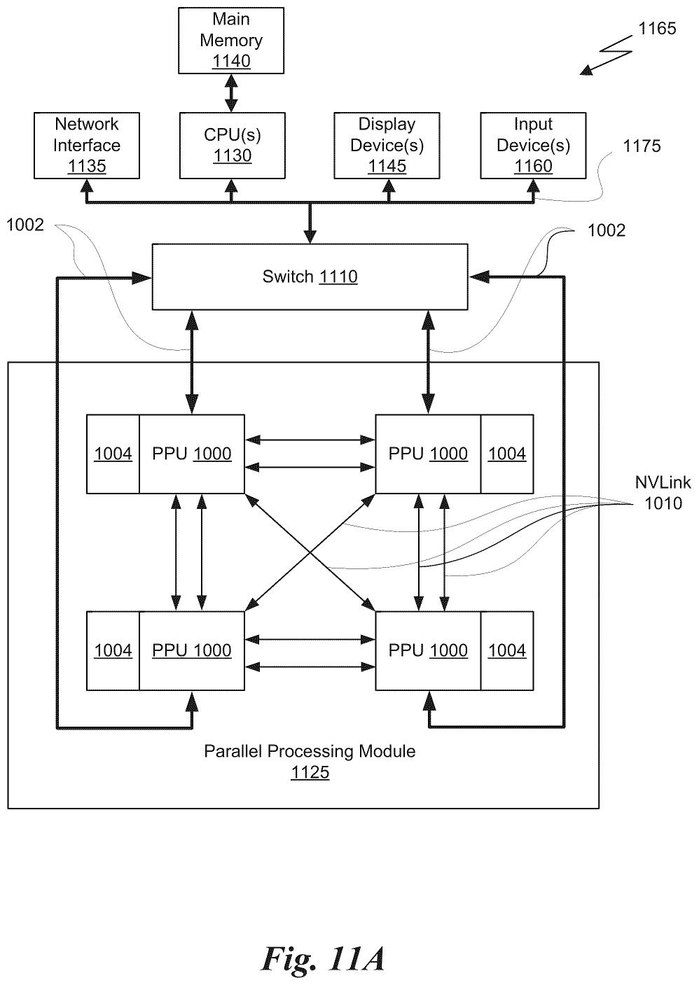

FIG. 10 is a conceptual diagram of a processing system 1100 implemented using multiple PPUs 1000, in accordance with an embodiment. Each parallel processing unit (PPU) 1000 may include hundreds or thousands of cores that are capable of handling hundreds or thousands of software threads simultaneously. The PPUs 1000 may generate pixel data for output images in response to rendering commands (e.g., rendering commands from the CPU(s) 1130 received via a host interface). The PPUs 1000 may include graphics memory, such as display memory, for storing pixel data or any other suitable data, such as GPU data. The display memory may be included as part of the memory 1004. The PPUs 1000 may include two or more GPUs operating in parallel (e.g., via a link). The link may directly connect the GPUs (e.g., using NVLINK 1010) or may connect the GPUs through a switch (e.g., using switch 1110). When combined together, each PPU 1000 may generate pixel data or GPGPU data for different portions of an output or for different outputs (e.g., a first PPU for a first image and a second PPU for a second image). Each PPU 1000 may include its own memory 1004, or may share memory with other PPUs 1000.

The PPUs 1000 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 1010 provides high-speed communication links between each of the PPUs 1000. Although a particular number of NVLink 1010 and interconnect 1002 connections are illustrated in FIG. 10, the number of connections to each PPU 1000 and the CPU 1130 may vary. The switch 1110 interfaces between the interconnect 1002 and the CPU 1130. The PPUs 1000, memories 1004, and NVLinks 1010 may be situated on a single semiconductor platform to form a parallel processing module 1125. In an embodiment, the switch 1110 supports two or more protocols to interface between various different connections and/or links.

In another embodiment (not shown), the NVLink 1010 provides one or more high-speed communication links between each of the PPUs 1000 and the CPU 1130 and the switch 1110 interfaces between the interconnect 1002 and each of the PPUs 1000. The PPUs 1000, memories 1004, and interconnect 1002 may be situated on a single semiconductor platform to form a parallel processing module 1125. In yet another embodiment (not shown), the interconnect 1002 provides one or more communication links between each of the PPUs 1000 and the CPU 1130 and the switch 1110 interfaces between each of the PPUs 1000 using the NVLink 1010 to provide one or more high-speed communication links between the PPUs 1000. In another embodiment (not shown), the NVLink 1010 provides one or more high-speed communication links between the PPUs 1000 and the CPU 1130 through the switch 1110. In yet another embodiment (not shown), the interconnect 1002 provides one or more communication links between each of the PPUs 1000 directly. One or more of the NVLink 1010 high-speed communication links may be implemented as a physical NVLink interconnect or either an on-chip or on-die interconnect using the same protocol as the NVLink 1010.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1125 may be implemented as a circuit board substrate and each of the PPUs 1000 and/or memories 1004 may be packaged devices. In an embodiment, the CPU 1130, switch 1110, and the parallel processing module 1125 are situated on a single semiconductor platform.

In an embodiment, the signaling rate of each NVLink 1010 is 20 to 25 Gigabits/second and each PPU 1000 includes six NVLink 1010 interfaces (as shown in FIG. 10, five NVLink 1010 interfaces are included for each PPU 1000). Each NVLink 1010 provides a data transfer rate of 25 Gigabytes/second in each direction, with six links providing 1000 Gigabytes/second. The NVLinks 1010 can be used exclusively for PPU-to-PPU communication as shown in FIG. 10, or some combination of PPU-to-PPU and PPU-to-CPU, when the CPU 1130 also includes one or more NVLink 1010 interfaces.

In an embodiment, the NVLink 1010 allows direct load/store/atomic access from the CPU 1130 to each PPU's 1000 memory 1004. In an embodiment, the NVLink 1010 supports coherency operations, allowing data read from the memories 1004 to be stored in the cache hierarchy of the CPU 1130, reducing cache access latency for the CPU 1130. In an embodiment, the NVLink 1010 includes support for Address Translation Services (ATS), allowing the PPU 1000 to directly access page tables within the CPU 1130. One or more of the NVLinks 1010 may also be configured to operate in a low-power mode.

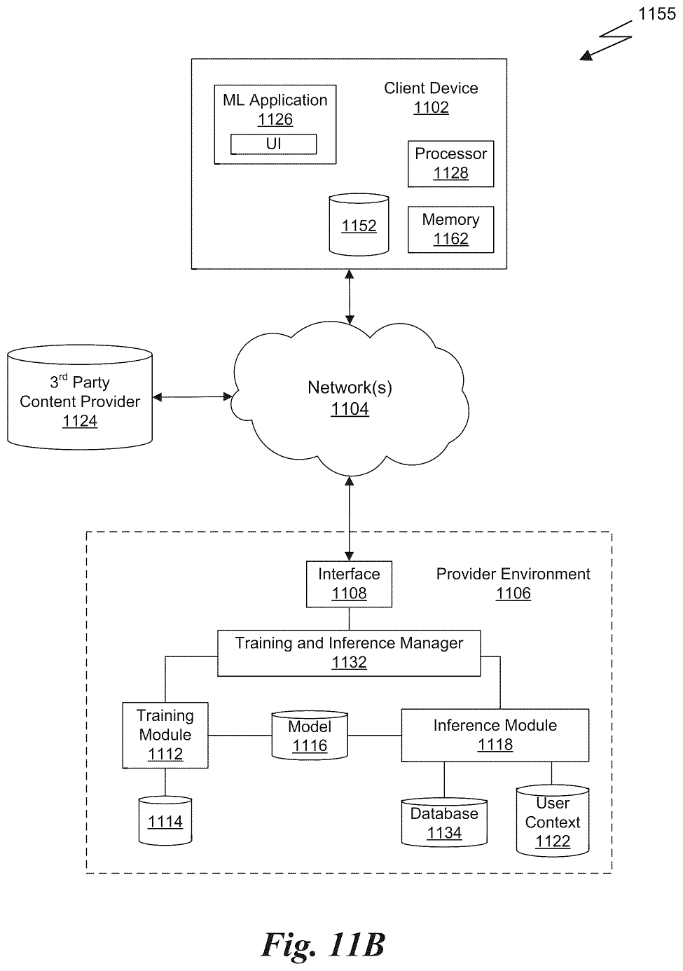

FIG. 11A illustrates an exemplary system 1165 in which the various architecture and/or functionality of the various previous embodiments may be implemented. The exemplary system 1165 may be configured to implement the method 300 shown in FIG. 3.

As shown, a system 1165 is provided including at least one central processing unit 1130 that is connected to a communication bus 1175. The communication bus 1175 may directly or indirectly couple one or more of the following devices: main memory 1140, network interface 1135, CPU(s) 1130, display device(s) 1145, input device(s) 1160, switch 1110, and parallel processing system 1125. The communication bus 1175 may be implemented using any suitable protocol and may represent one or more links or busses, such as an address bus, a data bus, a control bus, or a combination thereof. The communication bus 1175 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 1130 may be directly connected to the main memory 1140. Further, the CPU(s) 1130 may be directly connected to the parallel processing system 1125. Where there is direct, or point-to-point connection between components, the communication bus 1175 may include a PCIe link to carry out the connection. In these examples, a PCI bus need not be included in the system 1165.

Although the various blocks of FIG. 11A are shown as connected via the communication bus 1175 with lines, this is not intended to be limiting and is for clarity only. For example, in some embodiments, a presentation component, such as display device(s) 1145, may be considered an I/O component, such as input device(s) 1160 (e.g., if the display is a touch screen). As another example, the CPU(s) 1130 and/or parallel processing system 1125 may include memory (e.g., the main memory 1140 may be representative of a storage device in addition to the parallel processing system 1125, the CPUs 1130, and/or other components). In other words, the computing device of FIG. 11A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11A.

The system 1165 also includes a main memory 1140. Control logic (software) and data are stored in the main memory 1140 which may take the form of a variety of computer-readable media. The computer-readable media may be any available media that may be accessed by the system 1165. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 1140 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 1165. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 1165 to perform various functions. The CPU(s) 1130 may be configured to execute at least some of the computer-readable instructions to control one or more components of the system 1165 to perform one or more of the methods and/or processes described herein. The CPU(s) 1130 may each include one or more cores (e.g., one, two, four, eight, twenty-eight, seventy-two, etc.) that are capable of handling a multitude of software threads simultaneously. The CPU(s) 1130 may include any type of processor, and may include different types of processors depending on the type of system 1165 implemented (e.g., processors with fewer cores for mobile devices and processors with more cores for servers). For example, depending on the type of system 1165, the processor may be an Advanced RISC Machines (ARM) processor implemented using Reduced Instruction Set Computing (RISC) or an x86 processor implemented using Complex Instruction Set Computing (CISC). The system 1165 may include one or more CPUs 1130 in addition to one or more microprocessors or supplementary co-processors, such as math co-processors.

In addition to or alternatively from the CPU(s) 1130, the parallel processing module 1125 may be configured to execute at least some of the computer-readable instructions to control one or more components of the system 1165 to perform one or more of the methods and/or processes described herein. The parallel processing module 1125 may be used by the system 1165 to render graphics (e.g., 3D graphics) or perform general purpose computations. For example, the parallel processing module 1125 may be used for General-Purpose computing on GPUs (GPGPU). In embodiments, the CPU(s) 1130 and/or the parallel processing module 1125 may discretely or jointly perform any combination of the methods, processes and/or portions thereof.

The system 1165 also includes input device(s) 1160, the parallel processing system 1125, and display device(s) 1145. The display device(s) 1145 may include a display (e.g., a monitor, a touch screen, a television screen, a heads-up-display (HUD), other display types, or a combination thereof), speakers, and/or other presentation components. The display device(s) 1145 may receive data from other components (e.g., the parallel processing system 1125, the CPU(s) 1130, etc.), and output the data (e.g., as an image, video, sound, etc.).

The network interface 1135 may enable the system 1165 to be logically coupled to other devices including the input devices 1160, the display device(s) 1145, and/or other components, some of which may be built in to (e.g., integrated in) the system 1165. Illustrative input devices 1160 include a microphone, mouse, keyboard, joystick, game pad, game controller, satellite dish, scanner, printer, wireless device, etc. The input devices 1160 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 1165. The system 1165 may be include depth cameras, such as stereoscopic camera systems, infrared camera systems, RGB camera systems, touchscreen technology, and combinations of these, for gesture detection and recognition. Additionally, the system 1165 may include accelerometers or gyroscopes (e.g., as part of an inertia measurement unit (IMU)) that enable detection of motion. In some examples, the output of the accelerometers or gyroscopes may be used by the system 1165 to render immersive augmented reality or virtual reality.

Further, the system 1165 may be coupled to a network (e.g., a telecommunications network, local area network (LAN), wireless network, wide area network (WAN) such as the Internet, peer-to-peer network, cable network, or the like) through a network interface 1135 for communication purposes. The system 1165 may be included within a distributed network and/or cloud computing environment.

The network interface 1135 may include one or more receivers, transmitters, and/or transceivers that enable the system 1165 to communicate with other computing devices via an electronic communication network, included wired and/or wireless communications. The network interface 1135 may be implemented as a network interface controller (NIC) that includes one or more data processing units (DPUs) to perform operations such as (for example and without limitation) packet parsing and accelerating network processing and communication. The network interface 1135 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 1165 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 1165 may also include a hard-wired power supply, a battery power supply, or a combination thereof (not shown). The power supply may provide power to the system 1165 to enable the components of the system 1165 to operate.

Each of the foregoing modules and/or devices may even be situated on a single semiconductor platform to form the system 1165. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 1100 of FIG. 10 and/or exemplary system 1165 of FIG. 11A—e.g., each device may include similar components, features, and/or functionality of the processing system 1100 and/or exemplary system 1165.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 1100 of FIG. 10 and/or exemplary system 1165 of FIG. 11A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 1000 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 1000. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 1000 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 11B illustrates components of an exemplary system 1155 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 1106, while in at least one embodiment training might be requested by a customer or other user having access to a provider environment through a client device 1102 or other such resource. In at least one embodiment, training data (or data to be analyzed by a trained neural network) can be provided by a provider, a user, or a third party content provider 1124. In at least one embodiment, client device 1102 may be a vehicle or object that is to be navigated on behalf of a user, for example, which can submit requests and/or receive instructions that assist in navigation of a device.

In at least one embodiment, requests are able to be submitted across at least one network 1104 to be received by a provider environment 1106. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 1104 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 1108, which can forward data to a training and inference manager 1132, in this example. The training and inference manager 1132 can be a system or service including hardware and software for managing requests and service corresponding data or content, in at least one embodiment, the training and inference manager 1132 can receive a request to train a neural network, and can provide data for a request to a training module 1112. In at least one embodiment, training module 1112 can select an appropriate model or neural network to be used, if not specified by the request, and can train a model using relevant training data. In at least one embodiment, training data can be a batch of data stored in a training data repository 1114, received from client device 1102, or obtained from a third party provider 1124. In at least one embodiment, training module 1112 can be responsible for training data. A neural network can be any appropriate network, such as a recurrent neural network (RNN) or convolutional neural network (CNN). Once a neural network is trained and successfully evaluated, a trained neural network can be stored in a model repository 1116, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 1102 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 1108 and directed to inference module 1118, although a different system or service can be used as well. In at least one embodiment, inference module 1118 can obtain an appropriate trained network, such as a trained deep neural network (DNN) as discussed herein, from model repository 1116 if not already stored locally to inference module 1118. Inference module 1118 can provide data as input to a trained network, which can then generate one or more inferences as output. This may include, for example, a classification of an instance of input data. In at least one embodiment, inferences can then be transmitted to client device 1102 for display or other communication to a user. In at least one embodiment, context data for a user may also be stored to a user context data repository 1122, which may include data about a user which may be useful as input to a network in generating inferences, or determining data to return to a user after obtaining instances. In at least one embodiment, relevant data, which may include at least some of input or inference data, may also be stored to a local database 1134 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 1126 executing on client device 1102, and results displayed through a same interface. A client device can include resources such as a processor 1128 and memory 1162 for generating a request and processing results or a response, as well as at least one data storage element 1152 for storing data for machine learning application 1126.

In at least one embodiment a processor 1128 (or a processor of training module 1112 or inference module 1118) will be a central processing unit (CPU). As mentioned, however, resources in such environments can utilize GPUs to process data for at least certain types of requests. With thousands of cores, GPUs, such as PPU 1000 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 1102 for enhancement in provider environment 1106. In at least one embodiment, video data can be processed for enhancement on client device 1102. In at least one embodiment, video data may be streamed from a third party content provider 1124 and enhanced by third party content provider 1124, provider environment 1106, or client device 1102. In at least one embodiment, video data can be provided from client device 1102 for use as training data in provider environment 1106. In at least one embodiment, supervised and/or unsupervised training can be performed by the client device 1102 and/or the provider environment 1106. In at least one embodiment, a set of training data 1114 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 1114 is provided as training input to a training module 1112. In at least one embodiment, training module 1112 can be a system or service that includes hardware and software, such as one or more computing devices executing a training application, for training a neural network (or other model or algorithm, etc.). In at least one embodiment, training module 1112 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 1112 can select an initial model, or other untrained model, from an appropriate repository 1116 and utilize training data 1114 to train a model, thereby generating a trained model (e.g., trained deep neural network) that can be used to classify similar types of data, or generate other such inferences. In at least one embodiment where training data is not used, an appropriate initial model can still be selected for training on input data per training module 1112.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 1132 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 1000 comprises a graphics processing unit (GPU). The PPU 1000 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 1000 can be configured to process the graphics primitives to generate a frame buffer (e.g., pixel data for each of the pixels of the display).

An application writes model data for a scene (e.g., a collection of vertices and attributes) to a memory such as a system memory or memory 1004. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 1000 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 1004. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 1004. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

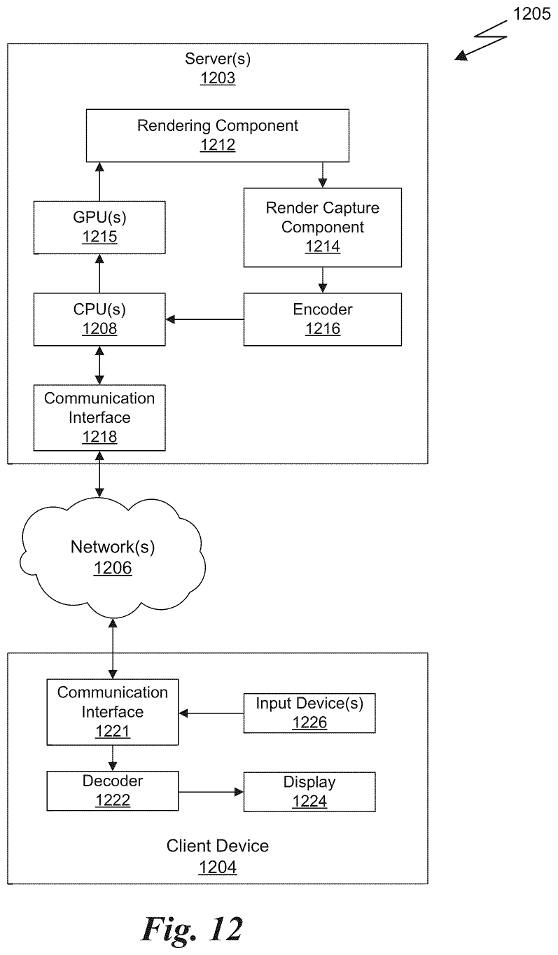

FIG. 12 is an example system diagram for a streaming system 1205, in accordance with some embodiments of the present disclosure. FIG. 12 includes server(s) 1203 (which may include similar components, features, and/or functionality to the example processing system 1100 of FIG. 10 and/or exemplary system 1165 of FIG. 11A), client device(s) 1204 (which may include similar components, features, and/or functionality to the example processing system 1100 of FIG. 10 and/or exemplary system 1165 of FIG. 11A), and network(s) 1206 (which may be similar to the network(s) described herein). In some embodiments of the present disclosure, the system 1205 may be implemented.

In an embodiment, the streaming system 1205 is a game streaming system and the server(s) 1203 are game server(s). In the system 1205, for a game session, the client device(s) 1204 may only receive input data in response to inputs to the input device(s) 1226, transmit the input data to the server(s) 1203, receive encoded display data from the server(s) 1203, and display the display data on the display 1224. As such, the more computationally intense computing and processing is offloaded to the server(s) 1203 (e.g., rendering—in particular ray or path tracing—for graphical output of the game session is executed by the GPU(s) 1215 of the server(s) 1203). In other words, the game session is streamed to the client device(s) 1204 from the server(s) 1203, thereby reducing the requirements of the client device(s) 1204 for graphics processing and rendering.

For example, with respect to an instantiation of a game session, a client device 1204 may be displaying a frame of the game session on the display 1224 based on receiving the display data from the server(s) 1203. The client device 1204 may receive an input to one of the input device(s) 1226 and generate input data in response. The client device 1204 may transmit the input data to the server(s) 1203 via the communication interface 1221 and over the network(s) 1206 (e.g., the Internet), and the server(s) 1203 may receive the input data via the communication interface 1218. The CPU(s) 1208 may receive the input data, process the input data, and transmit data to the GPU(s) 1215 that causes the GPU(s) 1215 to generate a rendering of the game session. For example, the input data may be representative of a movement of a character of the user in a game, firing a weapon, reloading, passing a ball, turning a vehicle, etc. The rendering component 1212 may render the game session (e.g., representative of the result of the input data) and the render capture component 1214 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 1203. The encoder 1216 may then encode the display data to generate encoded display data and the encoded display data may be transmitted to the client device 1204 over the network(s) 1206 via the communication interface 1218. The client device 1204 may receive the encoded display data via the communication interface 1221 and the decoder 1222 may decode the encoded display data to generate the display data. The client device 1204 may then display the display data via the display 1224.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A processor comprising:
one or more arithmetic logic units (ALUs) configured to use one or more neural networks to perform inference, the one or more neural networks comprising:
a plurality of multi-head attention (MHA) sub-blocks, each MHA sub-block comprising a plurality of attention heads;
a plurality of attention routers, each attention router corresponding to an MHA sub-block of the plurality of MHA sub-blocks, each attention router being configured to:
receive corresponding MHA sub-block input, and
route the corresponding MHA sub-block input to a selected candidate attention head set of the plurality of attention heads of the corresponding MHA sub-block, the selected candidate attention head set being selected based on one or more target deployment constraints; and
a plurality of multi-layer perceptron (MLP) sub-blocks, each MLP sub-block corresponding to an MHA sub-block of the plurality of MHA sub-blocks.

2. The processor according to claim 1, wherein each MLP sub-block of the plurality of MLP sub-blocks comprises at least one hidden layer, the at least one hidden layer comprising a plurality of neurons, the one or more neural networks further comprising:
a plurality of perceptron routers, each perceptron router corresponding to an MLP sub-block of the plurality of MLP sub-blocks, each perceptron router being configured to:
receive corresponding MLP input, and
route the corresponding MLP input to a selected candidate neuron set of the plurality of neurons of the at least one hidden layer of the corresponding MLP sub-block, the selected candidate neuron set being selected based on the one or more target deployment constraints.

3. The processor according to claim 1, wherein the selected candidate attention head set is one of a plurality of K nested candidate attention head sets.

4. The processor according to claim 3, wherein the plurality of attention heads of the corresponding MHA sub-block comprises L attention heads, and wherein each ith nested candidate attention head set, for i=1, 2, . . . , K, includes
$$i \frac{L}{K}$$
attention heads.

5. The processor according to claim 2, wherein the selected candidate attention head set is one of a plurality of K nested candidate attention head sets, and
wherein the selected candidate neuron set is one of a plurality of K nested candidate neuron sets.

6. The processor according to claim 5, wherein the plurality of attention heads of the corresponding MHA sub-block comprises L attention heads, and each ith nested candidate attention head set, for i=1, 2, . . . , K, includes attention heads, and
$$i \frac{L}{K}$$
wherein the plurality of neurons of the at least one hidden layer of the corresponding MLP sub-block comprises D neurons, and each jth nested candidate neuron set, for j=1, 2, . . . , K, includes
$$j \frac{D}{K}$$
neurons.

7. The processor according to claim 1, wherein each attention router is configured to route the corresponding MHA sub-block input to the selected candidate attention head set, the selected candidate attention head set being selected based on the one or more target deployment constraints and further based on the corresponding MHA sub-block input.

8. The processor according to claim 2, wherein each attention router is configured to route the corresponding MHA sub-block input to the selected candidate attention head set, the selected candidate attention head set being selected based on the one or more target deployment constraints and further based on the corresponding MHA sub-block input, and
wherein each perceptron router is configured to route the corresponding MLP input to the selected candidate neuron set, the selected candidate neuron set being selected based on the one or more target deployment constraints and further based on the corresponding MLP input.

9. The processor according to claim 2, wherein the plurality of attention heads of the corresponding MHA sub-block are ranked based on activations during pretraining,
wherein the plurality of neurons of the corresponding MLP sub-block are ranked based on activations during the pretraining, and
wherein the pretraining is performed using all of the plurality of attention heads of each MHA sub-block and using all of the neurons of the at least one hidden layer of each MLP sub-block.

10. The processor according to claim 2, wherein each of the plurality of MHA sub-blocks and each of the plurality of MLP sub-blocks is trained, at least in part, by a continued-training phase during which, for each MHA sub-block, the selected candidate attention head set of the plurality of attention heads is randomly sampled and, for each MLP sub-block, the selected candidate neuron set of the plurality of neurons is randomly sampled.

11. The processor according to claim 2, wherein each attention router comprises:
an input layer;
one or more hidden layers; and
an output layer,
wherein each perceptron router comprises:
an input layer;
one or more hidden layers; and
an output layer, and
wherein each attention router is configured to embed one or more scalar values corresponding to the one or more target deployment constraints into an embedding space, and
wherein each perceptron router is configured to embed one or more scalar values corresponding to the one or more target deployment constraints into the embedding space.

12. The processor according to claim 11, wherein each attention router is configured to:
embed the corresponding MHA sub-block input into the embedding space, and
route the corresponding MHA sub-block input to the selected candidate attention head set, the selected candidate attention head set being selected based on the one or more target deployment constraints and further based on the corresponding MHA sub-block input, and
wherein each perceptron router is configured to:
embed the corresponding MLP input into the embedding space, and
route the corresponding MLP input to the selected candidate neuron set, the selected candidate neuron set being selected based on the one or more target deployment constraints and further based on the corresponding MLP input.

13. A system comprising:
one or more arithmetic logic units (ALUs) configured to use one or more neural networks to perform inference, the one or more neural networks comprising:
a plurality of multi-head attention (MHA) sub-blocks, each MHA sub-block comprising a plurality of attention heads;
a plurality of attention routers, each attention router corresponding to an MHA sub-block of the plurality of MHA sub-blocks, each attention router being configured to:
receive corresponding MHA sub-block input, and
route the corresponding MHA sub-block input to a selected candidate attention head set of the plurality of attention heads of the corresponding MHA sub-block, the selected candidate attention head set being selected based on one or more target deployment constraints; and
a plurality of multi-layer perceptron (MLP) sub-block, each MLP sub-block corresponding to an MHA sub-block of the plurality of MHA sub-blocks.

14. The system according to claim 13, wherein each MLP sub-block of the plurality of MLP sub-blocks comprises at least one hidden layer, the at least one hidden layer comprising a plurality of neurons, the one or more neural networks further comprising:
a plurality of perceptron routers, each perceptron router corresponding to an MLP sub-block of the plurality of MLP sub-blocks, each perceptron router being configured to:
receive corresponding MLP input, and
route the corresponding MLP input to a selected candidate neuron set of the plurality of neurons of the at least one hidden layer of the corresponding MLP sub-block, the selected candidate neuron set being selected based on the one or more target deployment constraints.

15. The system according to claim 13, wherein the selected candidate attention head set is one of a plurality of K nested candidate attention head sets.

16. The system according to claim 15, wherein the plurality of attention heads of the corresponding MHA sub-block comprises L attention heads, and wherein each ith nested candidate attention head set, for i=1, 2, . . . , K, includes
$$i \frac{L}{K}$$
attention heads.

17. The system according to claim 13, wherein the selected candidate attention head set is one of a plurality of K nested candidate attention head sets, and
wherein the selected candidate neuron set is one of a plurality of K nested candidate neuron sets.

18. The system according to claim 17, wherein the plurality of attention heads of the corresponding MHA sub-block comprises Z attention heads, and each ith nested candidate attention head set, for i=1, 2, . . . , K, includes
$$i \frac{L}{K}$$
attention heads, and
wherein the plurality of neurons of the at least one hidden layer of the corresponding MLP sub-block comprises D neurons, and each jth nested candidate neuron set, for j=1, 2, . . . , K, includes
$$j \frac{D}{K}$$
neurons.

19. The system according to claim 13, wherein each attention router is configured to route the corresponding MHA sub-block input to the selected candidate attention head set, the selected candidate attention head set being selected based on the one or more target deployment constraints and further based on the corresponding MHA sub-block input.

20. The system according to claim 14, wherein each attention router is configured to route the corresponding MHA sub-block input to the selected candidate attention head set, the selected candidate attention head set being selected based on the one or more target deployment constraints and further based on the corresponding MHA sub-block input, and
wherein each perceptron router is configured to route the corresponding MLP input to the selected candidate neuron set, the selected candidate neuron set being selected based on the one or more target deployment constraints and further based on the corresponding MLP input.

21. The system according to claim 14, wherein the plurality of attention heads of the corresponding MHA sub-block are ranked based on activations during pretraining,
wherein the plurality of neurons of the corresponding MLP sub-block are ranked based activations during the pretraining, and
wherein the pretraining is performed using all of the plurality of attention heads of each MHA sub-block and using all of the neurons of the at least one hidden layer of each MLP sub-block.

22. A machine-readable medium having stored thereon a set of instructions, which if performed by one or more processors, cause the one or more processors to use one or more neural networks to perform inference, the one or more neural networks comprising:
a plurality of multi-head attention (MHA) sub-blocks, each MHA sub-block comprising a plurality of attention heads;
a plurality of attention routers, each attention router corresponding to an MHA sub-block of the plurality of MHA sub-blocks, each attention router being configured to:
receive corresponding MHA sub-block input, and
route the corresponding MHA sub-block input to a selected candidate attention head set of the plurality of attention heads of the corresponding MHA sub-block, the selected candidate attention head set being selected based on one or more target deployment constraints; and
a plurality of multi-layer perceptron (MLP) sub-blocks, each MLP sub-block corresponding to an MHA sub-block of the plurality of MHA sub-blocks.

23. The machine-readable medium according to claim 22, wherein each MLP sub-block of the plurality of MLP sub-blocks comprises at least one hidden layer, the at least one hidden layer comprising a plurality of neurons, the one or more neural networks further comprising:
a plurality of perceptron routers, each perceptron router corresponding to an MLP sub-block of the plurality of MLP sub-blocks, each perceptron router being configured to:
receive corresponding MLP input, and
route the corresponding MLP input to a selected candidate neuron set of the plurality of neurons of the at least one hidden layer of the corresponding MLP sub-block, the selected candidate neuron set being selected based on the one or more target deployment constraints.

24. The machine-readable medium according to claim 22, wherein the selected candidate attention head set is one of a plurality of K nested candidate attention head sets.

25. The machine readable medium according to claim 24, wherein each MLP sub-block of the plurality of MLP sub-blocks comprises at least one hidden layer, the at least one hidden layer comprising a plurality of neurons,
wherein the plurality of attention heads of the corresponding MHA sub-block comprises L attention heads, and each ith nested candidate attention head set, for i=1, 2, . . . , A, includes
$$i \frac{L}{K}$$
attention heads, and
wherein the plurality of neurons of the at least one hidden layer of the corresponding MLP sub-block comprises D neurons, and each jth nested candidate neuron set, for j=1, 2, . . . , K, includes
$$j \frac{D}{K}$$
neurons.

26. The machine-readable medium according to claim 23, wherein each attention router is configured to route the corresponding MHA sub-block input to the selected candidate attention head set, the selected candidate attention head set being selected based on the one or more target deployment constraints and further based on the corresponding MHA sub-block input, and
wherein each perceptron router is configured to route the corresponding MLP input to the selected candidate neuron set, the selected candidate neuron set being selected based on the one or more target deployment constraints and further based on the corresponding MLP input.

27. A method for performing inference using a sub-network selected from a dense neural network, the method comprising:
receiving, by a neural network, a plurality of input tokens, wherein the neural network comprises:
a plurality of multi-head attention (MHA) sub-blocks, each MHA sub-block comprising a plurality of attention heads providing, and
a plurality of multi-layer perceptron (MLP) sub-block, each MLP sub-block corresponding to an MHA sub-block of the plurality of MHA sub-blocks;
receiving, by an attention router corresponding to a respective MHA sub-block of the plurality of MHA sub-blocks, respective MHA sub-block input corresponding to a token of the plurality of tokens; and
routing, via the attention router, the respective MHA sub-block input to a selected candidate attention head set of the plurality of attention heads of the corresponding MHA sub-block,
wherein the selected candidate attention head set is selected based on one or more target deployment constraints.

28. The method according to claim 27, wherein each MLP sub-block of the plurality of MLP sub-blocks comprises at least one hidden layer, the at least one hidden layer comprising a plurality of neurons, the method further comprising:
receiving, by a perceptron router corresponding to a respective MLP sub-block of the plurality of MLP sub-blocks, respective MLP input corresponding to the token; and
routing, via the perceptron router, the respective MLP input to a selected candidate neuron set of the plurality of neurons of the at least one hidden layer of the corresponding MLP sub-block,
wherein the selected candidate neuron set is selected based on the one or more target deployment constraints.

29. The method according to claim 28, further comprising:
providing, for the plurality of attention heads of the corresponding MHA sub-block, a plurality of K nested candidate attention head set; and
providing, for the plurality of neurons of the at least one hidden layer of the corresponding MLP sub-block, a plurality of K nested candidate neuron sets.

30. The method according to claim 29, wherein the plurality of attention heads of the corresponding MHA sub-block comprises L attention heads, and each ith nested candidate attention head set, for i=1, 2, . . . , K, includes
$$i \frac{L}{K}$$
attention heads, and
wherein the plurality of neurons of the at least one hidden layer of the corresponding MLP sub-block comprises D neurons, and each jth nested candidate neuron set, for j=1, 2, . . . , K, includes
$$j \frac{D}{K}$$
neurons.
